(19) United States
(12) Patent Application Publication
(10) Pub. No.: US 2018/0148968 A1
(43) Pub. Date: May 31, 2018

(54) OBSTRUCTION DETECTION DEVICE

(71) Applicant: KABUSHIKI KAISHA TOKAI RIKA DENKI SEISAKUSHO, Aichi (JP)

(72) Inventor: Shuji SHITARA, Aichi (JP)

(73) Assignee: KABUSHIKI KAISHA TOKAI RIKA DENKI SEISAKUSHO, Aichi (JP)

(21) Appl. No.: 15/580,105

(22) PCT Filed: Jul. 12, 2016
(86) PCT No.: PCT/JP2016/070527

§ 371 Date: Dec. 6, 2017

(30) Foreign Application Priority Data
Jul. 17, 2015 (JP) 2015-143257

(51) Int. Cl. E05F 15/46; E05D 15/16

(52) U.S. Cl. CPC E05F 15/46; E05F 15/73; E05D 15/165

(57) ABSTRACT

An entrapment detection device includes a movable unit configured to move in cooperation with movement of an opening/closing body, an entrapment detection sensor arranged on the movable unit and configured to detect entrapment caused by the opening/closing body, and a conductive fixed body configured to contact the entrapment detection sensor during movement of the opening/closing body.

### TECHNICAL FIELD

The present invention relates to an entrapment detection device including an entrapment detection sensor that detects entrapment caused by an opening/closing body and is arranged on a movable unit that moves in cooperation with movement of the opening/closing body.

### BACKGROUND ART

Patent document 1 discloses a technique that arranges an electrostatic sensor on a door window, which is one example of an opening/closing body, and detects entrapment with the electrostatic sensor. When the electrostatic sensor detects entrapment as the door window closes, the movement of the door window is reversed. This releases an entrapment subject from the door window.

### PRIOR ART DOCUMENT

### Patent Document

Patent Document 1: Japanese Laid-Open Patent Publication No. 2008-297756

### SUMMARY OF THE INVENTION

### Problems that Are to be Solved by the Invention

When a sensor (for example, electrostatic sensor) used to detect entrapment by a power window is set on a movable unit such as a door window, a sensor electric wire moves in cooperation with vertical movement of the door window. This causes the following problem.

For example, it is difficult to obtain space for movement of an electric wire (including portion that connects sensor and electric wire, for example, connector) between a door window and a vehicle body.

Further, an electric wire may break when it moves and bends.

It is an object of the present invention to provide an entrapment detection device that allows the electric wire of the movable unit to be omitted.

### Means for Solving the Problem

One aspect of the present invention is an entrapment detection device. The entrapment detection device includes a movable unit configured to move in cooperation with movement of an opening/closing body, an entrapment detection sensor arranged on the movable unit and configured to detect entrapment caused by the opening/closing body, and a conductive fixed body configured to contact the entrapment detection sensor during movement of the opening/closing body.

In this configuration, the entrapment detection sensor (movable unit) contacts the conductive fixed body. Thus, the conductive fixed body forms part of the wiring. This allows the electric wire to be omitted from the movable unit.

### Effect of the Invention

The present invention allows the electric wire of the movable unit to be omitted.

### BRIEF DESCRIPTION OF THE DRAWINGS

FIG. 1A is a schematic view showing the wiring related to an electrostatic sensor in the configuration of a power window.

FIG. 1B is an enlarged view showing a guide structure that forms part of the wiring.

### EMBODIMENTS OF THE INVENTION

One embodiment of an entrapment detection device will now be described. The entrapment detection device of the present example is applied to a vehicle power window, which is one example of an opening/closing controller.

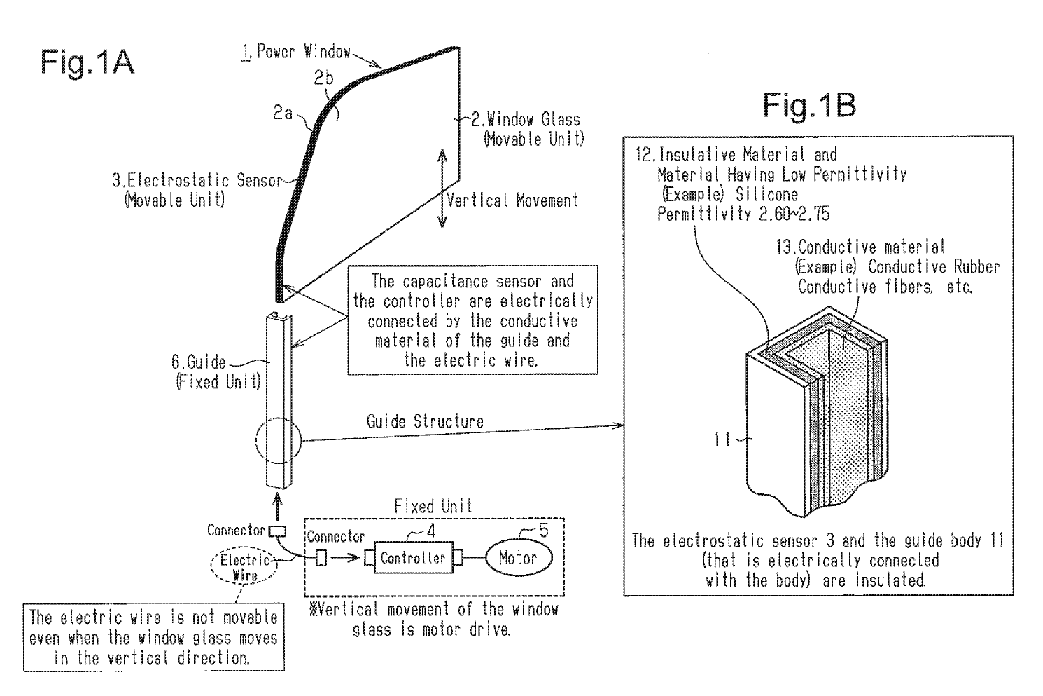

As shown in FIG. 1A, a power window 1 controls opening and closing movements of a window glass 2 of a vehicle door. The opening movement of the window glass 2 is defined by a lowering movement of the window glass 2, and the closing movement of the window glass 2 is defined by a lifting movement of the window glass 2. The window glass 2 corresponds to an opening/closing body and is a movable unit that moves in the vertical direction while sliding in a window frame (not shown). The window glass 2 slides in the vertical direction but may slide in the horizontal direction.

An electrostatic sensor 3, which is one example of an entrapment detection sensor, is arranged on an upper end surface of the window glass 2, an inclined end surface that is continuous with the upper end surface, and a side end surface that is continuous with the inclined end surface and located toward the front of the vehicle. Instead of or in addition to the side end surface located toward the front of the vehicle, the electrostatic sensor 3 may be arranged on a side end surface located toward the rear of the vehicle. The electrostatic sensor 3 affirmatively detects entrapment when the capacitance resulting from the accumulated electric charge becomes greater than or equal to a threshold value. In such a case, in addition to contact with a charged object, the electrostatic sensor 3 can detect the approach of a charged object depending on the setting of the threshold value. That is, the electrostatic sensor 3 is arranged on a distal end surface 2a of the window glass 2. The electrostatic sensor 3 may be arranged on two side surfaces of a distal end portion 2b of the window glass 2.

The power window 1 includes a controller 4 that centrally controls the opening and closing movements of the window glass 2, a motor 5 that is a power source for the opening and closing movements of the window glass 2, and an operation switch (not shown) used for an operation input that starts the opening or closing movement of the window glass 2. The operation switch is arranged near a seat. When an operation input is performed on the operation switch, the operation input is recognized by the controller 4. As a result, when a user performs an opening operation on the operation switch, an opening movement lowers the window glass 2 under the control of the controller 4 while driving an actuator that includes the motor 5. When the user performs a closing operation on the operation switch, a closing movement lifts the window glass 2 under the control of the controller 4.

The opening operation and the closing operation can both be performed as either one of a manual operation that stops movement of the window glass 2 when the manual operation is cancelled and an automatic operation that continues movement of the window glass 2 until the window glass 2 reaches a fully-open position or a fully-closed position. In the automatic operation, an operation for continuing a lowering movement of the window glass 2 until the window glass 2 reaches the fully-open position is referred to as the “automatic down operation,” and an operation for continuing a lifting movement of the window glass 2 until the window glass 2 reaches the fully-closed position is referred to as the “automatic up operation.”

The controller 4 analyzes a detection signal of capacitance by the electrostatic sensor 3. When the electrostatic sensor 3 affirmatively detects entrapment during a lifting movement of the window glass 2 started as an automatic up operation, the controller 4 reverses movement of the window glass 2. This releases an entrapped subject from the window glass 2.

In order to electrically connect the electrostatic sensor 3 and the controller 4, the power window 1 includes a guide 6 and an electric wire 7. The electric wire 7 is not particularly limited as long as it electrically connects the electrostatic sensor 3 and the controller 4. For example, the electric wire 7 is a cable or a wiring harness.

As shown in FIG. 1B, the guide 6 includes a guide body 11, an insulative material 12, and a conductive material 13. The Guide body 11 is formed from a metal having superior conductivity and processed to have a U-shaped cross section. The insulative material 12 has a predetermined thickness at an inner side of the guide body 11. The conductive material 13 has a predetermined thickness at an inner side of the insulative material 12. The guide body 11 is fixed to the vehicle body through welding or the like. The potential at the guide body 11 is the same as the potential at a body of the vehicle that is connected to ground and the GND level potential at an electric circuit including the electrostatic sensor 3. The insulative material 12 corresponds to an insulator arranged between the metal guide body 11 and the conductive material 13. It is preferred that a material having low permittivity such as silicone be used as the insulative material 12. The conductive material 13 corresponds to a conductive fixed body that is in constant contact with the electrostatic sensor 3 during movement of the window glass 2. For example, conductive rubber or conductive fibers can be used as the conductive material 13.

The length of the conductive material 13 in the vertical direction is set so that the part of the electrostatic sensor 3 located at a lower end portion of a side end portion of the window glass 2 contacts an upper end portion of the conductive material 13 when the window glass 2 is located at the fully-closed position (upper limit position) and the part of the electrostatic sensor 3 located at an upper end portion of the side end surface of the window glass 2 contacts a lower end portion of the conductive material 13 when the window glass 2 is located at the fully-open position (lower limit position). Thus, when the window glass 2 moves in the vertical direction between the fully-closed position and the fully-open position, part of the electrostatic sensor 3, which is arranged on the side end surface of the window glass 2, is in constant contact with the conductive material 13. In order to ensure that the electrostatic sensor 3 is in contact with the conductive material 13, the electrostatic sensor 3 may be extended from the side end surface of the window glass 2 toward a side surface of the window glass 2 located inside the passenger compartment or toward a side surface of the window glass 2 located outside the passenger compartment.

Returning to FIG. 1A, two ends of the electric wire 7 each include a connector. One of the connectors is attached to a lower end portion of the guide 6, and the other connector is fitted to a mating connector incorporated in the controller 4. This electrically connects the electrostatic sensor 3 and the controller 4 through the conductive material 13 of the guide 6 and the electric wire 7, which is located between the conductive material 13 and the controller 4.

The operation of the power window 1 will now be described.

When the window glass 2 is coupled to the guide 6, the electrostatic sensor 3 comes into contact with the conductive material 13. Then, when the lower end portion of the guide 6 is connected to the controller 4 by a harness (including electric wire 7 and connectors at its two ends), the wiring is completed.

When the motor 5 is driven under the control of the controller 4, the window glass 2 moves in the vertical direction guided by the guide 6. Part of the wiring is formed by contact of the electrostatic sensor 3 (movable unit) with the conductive material 13. The wiring of the conductive material 13 and the wire 7 electrically connects the electrostatic sensor 3 and the controller 4. The guide 6 and the controller 4 are both fixed units. The electric wire 7, which is arranged between the guide 6 and the controller 4, is also included in the fixed units. Thus, the electric wire 7 cannot move even if the window glass 2 moves in the vertical direction.

As described above, the present embodiment has the following advantages.

(1) The wiring is partially formed by contact of the electrostatic sensor 3 (movable unit) with the conductive material 13 of the guide 6 (fixed unit). This allows an electric wire (electric wire directly connected to electrostatic sensor 3) to be omitted from the movable unit. Since the movable unit does not include an electric wire, there is no need to provide space for movement of an electric wire and wire breakage does not occur.

(2) When the guide 6 is coupled to the window glass 2 to guide the window glass 2, the electrostatic sensor 3 can contact the conductive material 13. This facilitates connection of the electrostatic sensor 3.

(3) When the metal guide body 11 is connected to the vehicle body that is connected to ground and the conductive material 13 is connected to the electrostatic sensor 3, the insulative material 12 insulates the guide body 11 and the conductive material 13. The performance of the electrostatic sensor 3 can be increased by using a material having low permittivity as the insulative material 12.

(4) Even when the electric wire 7 is arranged between the guide 6 and the controller 4, the electric wire 7 is arranged on a fixed unit. This realizes wiring that will not break.

(5) When the guide body 11 of the guide 6 of the present example is used as a conventional guide, the arrangement of the insulative material 12 and the conductive material 13 on the conventional guide allows the electric wire to be omitted from the movable unit. Thus, there is no need for drastic changes in components.

The above embodiment may be modified as described below.

When a coating (protection layer) is applied to a surface of the electrostatic sensor 3, the coating may be omitted at portions where the electrostatic sensor 3 contacts the conductive material 13 to ensure electrical connection with the conductive material 13.

The conductive fixed body that is in contact with the electrostatic sensor 3 may be divided into a first conductor that contacts an anode of a sensor electrode of the electrostatic sensor 3 and a second conductor that contacts a cathode of the sensor electrode. In this case, the second conductor is connected to the body of the vehicle that is connected to ground.

Instead of an electrostatic sensor, the present invention may be applied to an entrapment detection device including, for example, an entrapment detection sensor that uses a pressure-sensitive sensor and is arranged on the movable unit.

The insulative material 12 is not limited to silicone.

The conductive material 13 is not limited to a conductive rubber or conductive fibers. It is preferred that an elastic material that allows for satisfactory connection when in contact with the electrostatic sensor 3 and has superior wear resistance be employed. It is further preferred that a combination of materials having superior durability be selected in correspondence with the electrostatic sensor 3.

The entrapment detection device according to the present invention may be applied to an opening/closing control device that controls an opening/closing body such as a shutter of a building in which an opening movement is defined by a lifting movement and a closing movement is defined by a lowering movement. In this case, an entrapment detection sensor is set on a shutter or the like, which is an opening/closing body.

The entrapment detection device according to the present invention may be applied to an opening/closing control device that controls an opening/closing body that moves in the horizontal direction, for example, a sliding door of a vehicle or an automatic door of a building. In this case, the entrapment detection sensor is set on a door or the like, which is an opening/closing body.

The entrapment detection device according to the present invention may be applied to an opening/closing control device that controls a sunroof or the like of a vehicle. In this case, the entrapment detection sensor is set on the sunroof or the like, which is an opening/closing body.

1. An entrapment detection device comprising:
a movable unit configured to move in cooperation with movement of an opening/closing body;
an entrapment detection sensor arranged on the movable unit, wherein the entrapment detection sensor is configured to detect entrapment caused by the opening/closing body; and
a conductive fixed body configured to contact the entrapment detection sensor during movement of the opening/closing body.

2. The entrapment detection device according to claim 1, further comprising a guide that guides the opening/closing body during movement of the opening/closing body, wherein
the guide includes the conductive fixed body.

3. The entrapment detection device according to claim 2, wherein the guide includes
a metal guide body
an insulator arranged between the metal guide body and the conductive fixed body.

4. The entrapment detection device according to claim 1, comprising a controller configured to analyze a detection signal generated by the entrapment detection sensor, wherein
the controller is configured to be connectable to the conductive fixed body by an electric wire.

5. The entrapment detection device according to claim 1, wherein the conductive fixed body includes
a first conductor that contacts an anode of a sensor electrode of the entrapment detection sensor, and
a second conductor that contacts a cathode of the sensor electrode of the entrapment detection sensor.
